(19) United States
(12) Patent Application Publication
(10) Pub. No.: US 2005/0172340 A1
(43) Pub. Date: Aug. 4, 2005

(54) Method and system for distributed content management and delivery

(76) Inventors: Oleg Logvinov, East Brunswick, NJ (US); Brion Ebert, Easton, PA (US)

Correspondence Address: NORRIS MCLAUGHLIN & MARCUS, P.A., P O BOX 1018, SOMERVILLE, NJ, 08876, US

(21) Appl. No.: 10/938,905

(22) Filed: Sep. 10, 2004

Related U.S. Application Data
(60) Provisional application No. 60/502,477, filed on Sep. 12, 2003.

(51) Int. Cl. G06F 17/60

(52) U.S. Cl. 726/26; 705/51

(57) ABSTRACT

Management and control of distribution of multiple, simultaneously occurring audio and video data content streams in a communications network, as well as of the bandwidth used for distributing the content of the network, is performed at a master content server module to provide that content source and content rendering client devices operate in unison. Distribution of content is managed to economize use of network bandwidth and maximize network performance to provide that enhanced features associated with content distribution can be readily made available with the content at the client devices.

### CROSS REFERENCE TO RELATED APPLICATION

This application claims the benefit of U.S. Provisional Application No. 60/502,477 filed Sep. 12, 2003, assigned to the assignee of this application and incorporated by reference herein.

### FIELD OF THE INVENTION

The present invention relates generally to the distribution of content, such as audio, video or other data, over a local or wide area communications network, and, more particularly, to managing the distribution of content over a local or wide area communications network in response to requests for delivery of content by a plurality of client devices located throughout the network.

### BACKGROUND OF THE INVENTION

Currently, there are several types of packet-based communications networks that provide for distribution of content, such as audio, video or other data, in residences and businesses utilizing infrastructures provided by a local area network, a wide area network or a combination of the two. In the majority of such content distribution communications networks existing today, data is exchanged among a number of communications devices based primarily upon the actions performed at any one of the devices. In home entertainment and related packet-based communications networks that provide for content distribution, the data, or data patterns, are usually categorized into three main types: streamed, control and request, and content information. Streamed refers to audio and video data of various formats, such as MPEG1, MPEG2, MPEG3, AVI, etc. Control and request refers to data that relates to management and control of the audio and video streams. Content information refers to data related to the specifics of audio or video streams available for distribution on a network. The bulk, or largest portion, of the data transmitted on such networks is usually the streamed data, where the streamed data can be represented by a sequence of packets.

The bulk of current home entertainment and similar networks operate primarily where one or possibly two devices in the network request content at any one time. Therefore, in such networks, it is assumed that the extent of content streaming will involve one or two devices and that primarily one device will initiate substantially all of the actions that occur on the network at any one time. It is also common that such networks are based upon ad-hoc and contention resolution methods of media access and data communication at the lower network protocol layers that do not lend well to the handling of streaming content.

In future content distribution communications networks, it is expected that multiple streams will need to occur simultaneously and can be controlled or requested from various network devices throughout the network, and that the sources of these streams can be one or multiple devices in the network. Consequently, in some circumstances where multiple streams need to be transmitted simultaneously over a content distribution communications network, it is possible that the bandwidth of the network can become taxed. Further, future content distribution communications networks will likely be of a complexity that requires performance of stream management functions related to bandwidth allocation, security, lifetime, digital rights management and other like items.

In current communications networks, the above-type stream management functions would likely be performed at the source of the content being delivered, if the source even includes such functionality at all. In addition, current communications network content management and distribution techniques do not provide for distributing the functionalities, which are expected to be required in future communications networks, throughout the network to minimize complexity of control of content distribution and facilitate satisfactory distribution of content to a plurality of client devices simultaneously requesting content. For example, end-to-end security and complete rights management are not readily accomplished and handled in current networks as both the source and destination devices of any particular content are not aware of and do not themselves include the necessary rights management functionalities. Furthermore, as a single source and/or destination device operating at any one time will no longer represent the norm in future communications networks, the ability to provide for interaction among, and unified control of, the devices in the network in real time, which does not exist in current communications network, will be required.

Therefore, a need exists for management of the distribution of content over a content distribution communications network to provide for real time, unified control of content handling and digital rights management and optimization of network bandwidth allocation in view of requests for content by client devices of the network.

### SUMMARY OF THE INVENTION

In accordance with the present invention, distribution of content, such as streaming audio and video and multimedia content, among a plurality of devices located throughout a content distribution communications network is managed to provide for unified control of use of network bandwidth, content management functions and distribution, such as streaming, of the content itself. Unified content management provides for flexible and robust control of content distribution in the network and optimization of network bandwidth, such as in the presence of multiple, varied, simultaneous audio and video data streams. The content, preferably, can be sourced (originated), captured, stored, transmitted, received and rendered at any of the content devices of the network.

In a preferred embodiment, a centralized master content server management device controls multiple content source devices and also the client devices that are distributed over the network and constitute the destinations for the content. The master content server device interacts with the client devices to provide for unified control and management of the distributed content data streams.

In a preferred embodiment, the content distribution communications network is a home entertainment or similar type of network in the form of a local area or wide area broadband power line network.

### BRIEF DESCRIPTION OF THE DRAWINGS

Other objects and advantages of the present invention will be apparent from the following detailed description of the presently preferred embodiments, which description should be considered in conjunction with the accompanying drawings in which like references indicate similar elements and in which:

FIG. 1 is a block diagram of a master content management server device and a client device for implementation on a content distribution communications network in accordance with the present invention.

FIG. 2 illustrates content delivery on a content distribution communications network using the master device and the client device of FIG. 1.

### DETAILED DESCRIPTION OF THE INVENTION

For purposes of highlighting the features of the present invention, management of distribution of content among a plurality of devices located throughout a content distribution communications network is described in connection with content distribution over a broadband powerline network and a local area network operating based on powerline communication. It is to be understood, however, that the present invention is applicable on a network based on any medium, wired or wireless.

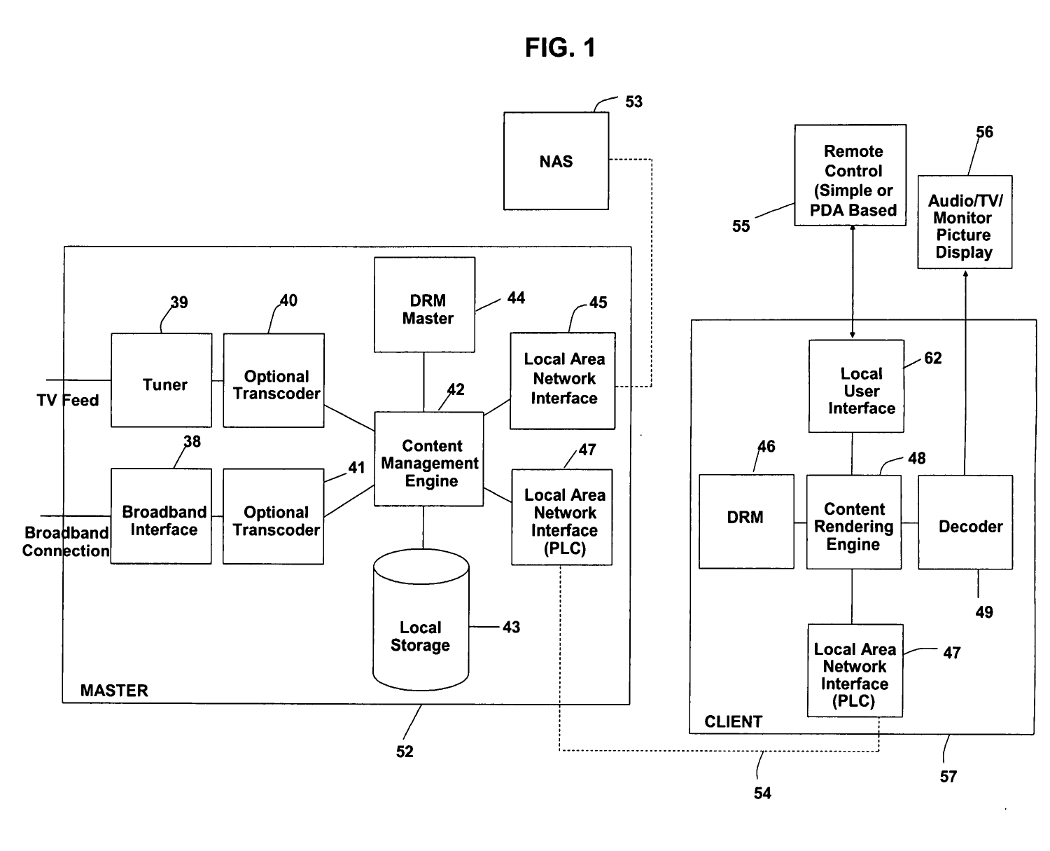

FIG. 1 illustrates a block diagram of a preferred embodiment of a master content server management device 52 connected to a client content management device 57 in accordance with the present invention of managing distribution of content over a content distribution communications network. The present invention operates in connection with an overall communications system architecture, includes system components having an architecture, and uses methods and algorithms relating to system bandwidth determination, system synchronization, content rendering synchronization, content distribution, content protection, content transcoding (such as MPEG 2 to MPEG 4, MPEG 2 to Windows Media 9, etc.), content rendering and overall system optimization, such as described in detail in U.S. application Ser. No. 10/293,129, filed Nov. 13, 2002; U.S. application Ser. No. 09/290,353, filed Apr. 12, 1999; U.S. Provisional Application No. 60/415,111, filed Sep. 30, 2002; U.S. application Ser. No. 10/671,126, filed Sep. 25, 2003; U.S. Provisional Application No. 60/413,302, filed Sep. 25, 2002; U.S. Provisional Application No. 60/415,111 filed Sep. 30, 2002; U.S. application Ser. No. 10/671,126 filed Sep. 25, 2003; U.S. application Ser. No. 10/280,555, filed Oct. 25, 2002; U.S. application Ser. No. 10/293,129, filed Nov. 13, 2002; U.S. application Ser. No. 10/430,087, filed Oct. 29, 2002; U.S. Provisional Application for “Adaptive Multimedia Content Delivery System With Location Based Control and Management”, filed Aug. 31, 2004; U.S. Provisional Application for “A Hybrid Broadband Access System for MDU/MTU Environments”, filed Aug. 31, 2004; U.S. Application Ser. No. 10/645,237, filed Aug. 21, 2003; and U.S. application Ser. No. 10/646,413, filed Aug. 21, 2003, each of which is assigned to the assignee of the present invention and incorporated by reference herein.

Referring to FIG. 1, the master device 52 includes one or more broadband communication interfaces, including for example a powerline interface 47 and optionally a cable or DSL interface 38, and also an analog interface 39 to a cable or TV feed. In addition, the master device 52 optionally includes a local interface 45 to a network attached storage (“NAS”) device 53. The client device 57 also includes a broadband power line interface 47 and a local interface 62 for interfacing with end point devices, such as a remote control or a PDA 55. The client device 57 also includes a decoder 49 for interfacing with end point playback devices 56, such as speakers, stereo inputs, TV, monitor, LCD, etc. In a normal content delivery communications network implementation, multiple client devices 57 are connected to a broadband power line communications (“PLC”) network 54 and interface with other client devices as well as the master device 52.

In the master device 52, a content management engine 42 controls the communication and interaction between the other functional blocks within the master device 52. The content management engine 42 preferably has an interface with each of the available content sources in a local area or wide area network. Some of these interfaces may include optional transcoders 40, 41 that process the content data streams so that a universal format data stream is presented to the content management engine 42. Additionally, the content management engine 42 has an interface to a local storage 43 that itself can be a source of streaming content, or alternatively can be used to buffer and store other streams as may be required for synchronization of multiple streams or temporary storage and playback of a stream, respectively. The content management engine 42 controls the sources of the data streams based on the input it receives from the requesting client devices 54 present on the PLC network 54, and also handles the management of bandwidth allocation and control of the PLC network 54.

In operation, the content management engine 42 receives from the client devices 57, through the PLC interface 47, input data representative of the requested audio and video streams that a client device receives from the associated remote control or PDA device 55 to which the client device is coupled. The content management engine 42 manages transmission of the requested streams, through the PLC interface 47, to the client devices 57. The content is received at the master module 52 from the interface 38 and includes associated data, such as content metadata, external information feed data, special indexes and pre-configured or dynamically created associations, such as filename based associations, that permits the engine 42 to generate, for example, programming guide information and content related data for transmission with the content. At the client devices 57, the content rendering engine 48 manages output of the requested stream, received from the master device 52, to the associated playback device 56 for listening or viewing, with or without the programming guide information.

In a preferred embodiment, the content rendering engine of a client device, in conjunction with the local PLC interface 47, supplies to the master device input data on current and future bandwidth requirements, physical network local link status and parameters related to current capacity and network behavior over time, buffer allocation requirements based on anticipated congestion periods and other related information. The content management engine of the master device can use such information to more effectively and efficiently utilize the network bandwidth in accordance with the present invention.

In a further preferred embodiment, the content management engine 42 at the master device, based on information received from the client devices, as well as from information and historical data stored locally at the storage 43, determines the proper bandwidth allocation and management for all of the streams currently being transmitted. Based upon the historical data stored at the storage 43, as well as current PLC network medium conditions determined at the PLC interface 47 using techniques known in the art, the content management engine 42 allocates sufficient bandwidth, based upon frequency division multiplexing (FDM), frequency band allocation or other techniques well known in the art, for each stream currently being transmitted to allow for proper resolution or accuracy of the original stream. If sufficient bandwidth is not available on the communications network to handle all of the current streaming content, or a bandwidth limiting event takes place such as increased noise on the PLC medium, the master and client devices interact, in accordance with the present invention, to temporarily reduce the resolution of one or more of the streams, employ increased buffering or other stream interruptance avoidance methods, or utilize other methods to minimize the effect of these conditions on the playing or playback of any streaming content. For example, the amount of memory available in a client device for storing content can be modified, as suitable, depending on the number of streams simultaneously occurring and the congestion that may be expected to occur on the network.

In a further preferred embodiment involving distribution of streams having associated rights or lifetimes, the content management engine 42 of the master device 52 exchanges information with the content rendering engine 48 of a client device to provide for Digital Rights Management (DRM). The content management engine 42 interfaces with a DRM Master 44 to provide DRM information to DRM sub-agents 46, through the content rendering engines 48 in respective client devices 57, to ensure management and control of the restricted streams based on their parameters, where the content restriction is performed using techniques well known in the art.

The decoder 49 within a client device provides that an associated master device can send high bandwidth streams to the client device in a compressed, encoded and encrypted format. Advantageously, the decoder at the client device provides that the master device can “feed through” the streams received from the broadband interface, such that only minimal processing needs to be performed at the master device.

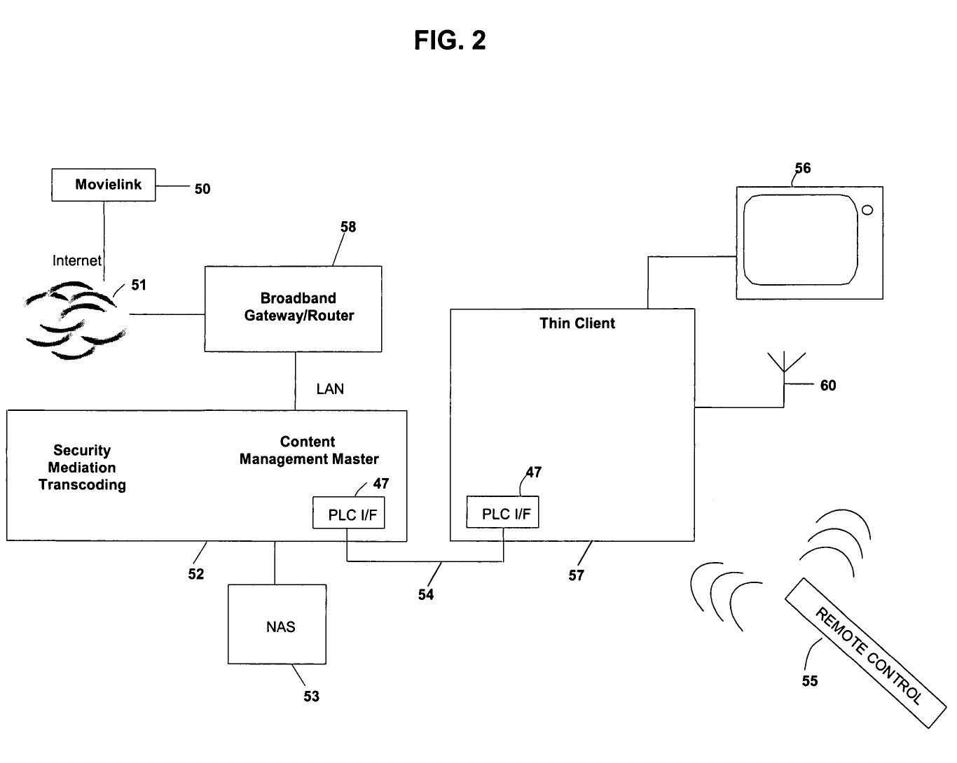

FIG. 2 illustrates an exemplary, secure content delivery implementation where movie content 50 is rented and download for viewing. The movie content is downloaded based on input from the user, through selections made on the remote control 55, based on a menu or other presentations that a master content management server device 52, which can be a DVR/PVR type device, generates and transmits to the client device 57, which can be a thin client device. The movie content 50 then is displayed on the attached TV 56, for example. The movie content is downloaded through the internet 51 and a broadband gateway/router 58, as known in the art, to the master device 52 and then stored on a network attached storage (NAS) device 53 connected to the master device 52. The master device 52 manages distribution of the movie content 50 based on parameters associated with the movie content. For example, the movie content 50 can include associated, specific rental parameters that the content management master device 52 processes to control, for example, the amount of time the content resides on a storage device within the master device 52 and the amount of viewing time available once the movie is started. In addition, the master device 52 interacts with the client device, over the powerline network 54, for streaming the movie content to a TV or other viewing device, based on input transmitted from the remote device 55 and received at antenna 60 of the client device 57.

It is to be understood that the exemplary management of distributed content described with reference to FIG. 2 is one of many possible uses of distributed content management and delivery within a multimedia network in accordance with the present invention, and one skilled in the art may realize many other applications and advantages for maximum bandwidth utilization in accordance with the present invention.

In a preferred embodiment, the invention can be used in (1) a broadband power line access network that provides connectivity to homes, businesses and other entities, or (2) a high-speed local area power line network in a home, business or other environment that provides connectivity among devices located within the environment.

Although preferred embodiments of the present invention have been described and illustrated, it will be apparent to those skilled in the art that various modifications may be made without departing from the principles of the invention.

1. A system for managing distribution of content on a communications network having a predetermined bandwidth and a real time capacity and to which a plurality of client devices are coupled, the system comprising:
a master content management server module including a content management engine coupled to a broadband interface and a network interface, wherein the broadband interface is for receiving content and the network interface is for coupling to the communications network and generates communications network performance characteristics; and
a content rendering engine contained within each of the client devices coupled to the network, wherein the content rendering engine transmits content request information to the master module,
wherein the content management engine manages distribution of content to the client devices and optimizes allocation of the predetermined network bandwidth based on the content request information and the communications network performance.

2. The system of claim 1, wherein the content management engine selectively performs compression and encoding on the content based on the real time capacity of the communications network.

3. The system of claim 1, wherein the content management engine reserves bandwidth in view of active and scheduled streams and data transfers represented by the content request information.

4. The system of claim 1, wherein the content rendering engine includes a memory whose size is modifiable in anticipation of congestion in the network.

5. The system of claim 1, wherein the content management engine determines patterns of media behavior and resulting media capacity based on the communications network performance characteristics.

6. The system of claim 1, wherein the network is a powerline communications network.

7. The system of claim 1, wherein at least one of the content management engine and the content rendering engine in a first client device controls Digital Rights Management (DRM) of content, and wherein at least one of the master module and the first client device functions as a DRM sub-agent.

8. The system of claim 7, wherein at least one of the content management engine and the content rendering engine performs user authentication.

9. The system of claim 7, wherein the client device performing rendering of content performs user authentication.

10. The system of claim 7, wherein the master module includes a memory for storing content, wherein the content management engine performs transcoding functions and wherein the client devices do not include local storage.

11. The system of claim 10, wherein the master module includes a network attached storage (NAS) coupled to the content management engine via a network interface, wherein the NAS is for storing content.

12. The system of claim 7, wherein the content management engine, based on source data associated with content and including at least one of content metadata, external information feed data, special indexes and pre-configured or dynamically created associations, generates content related information and programming guide information.

13. The system of claim 12, wherein the content management engine superimposes the content related information and the programming guide information over the content.

14. The system of claim 13, wherein the superimposing of the information provides that the information is presented separately on a same display as the content itself, and wherein the display is associated with the client device receiving the content.

15. The system of claim 13, wherein the content related information and the programming guide information are presented on a remote control device equipped with a presentment interface, and wherein the remote control is associated with the client device receiving the content.

16. The system of claim 10, wherein the transcoding is implemented on at least one of the master module and a client device containing or interfaced with a storage device for optimizing network bandwidth usage.

17. The system of claim 16, wherein at least one of the master module and the client devices coupled to the network control transcoding for content distribution on the network.

18. The system of claim 7, wherein at least one of the master module and the client device perform content transformation from one transport protocol into another and perform security protocol mediation.

19. The system of claim 7, wherein the content management engine synchronizes playback of the content among a plurality of the client devices using a specialized time synchronization protocol.

20. The system of claim 19, wherein the content playback is phase aligned among the plurality of the client devices.

21. The system of claim 7, wherein the content management engine allocates bandwidth to content based on prior knowledge of the bandwidth demands for the network.

22. The system of claim 1, wherein the content management engine performs a specific middleware that abstracts specific content types and storage devices to provide that any type of content type can be accessed by any of the client devices through a unified interface.

23. The system of claim 22, wherein the network is a power line network.

24. The system of claim 22, wherein the content management engine encodes the content and the programming guide information for presentment based on presentment capabilities of the client device that will render the content.
